(19) United States
(12) Patent Application Publication
(10) Pub. No.: US 2010/0089460 A1
(43) Pub. Date: Apr. 15, 2010

(54) VALVE, DEVICE AND METHOD FOR THE GENERATION OF A FLUID PULSE

(75) Inventor: Franz Durst, Langensendelbach (DE)

Correspondence Address: KANESAKA BERNER AND PARTNERS LLP, 1700 DIAGONAL RD, SUITE 310, ALEXANDRIA, VA, 22314-2848, US

(73) Assignee: FMP Fluid Measurements and Projects GmbH, Erlangen (FR)

(21) Appl. No.: 12/449,324

(22) PCT Filed: Feb. 4, 2008
(86) PCT No.: PCT/EP2008/000868

§ 371 Date: Sep. 3, 2009

(30) Foreign Application Priority Data
Feb. 5, 2007 (DE) 10 2007 006 415.4

(51) Int. Cl. B67D 7/08; F16K 31/02

(52) U.S. Cl. 137/12; 251/129.15; 137/565.16

(57) ABSTRACT

The invention relates to a valve (16), in which a fluid inlet opening provided in a valve housing (1) is connected to a fluid outlet opening (3) downstream of the fluid inlet opening by a fluid passage (2) and with a valve closing body (6) which may be moved between a first position which opens the fluid outlet opening (3) and a second position closing the fluid outlet opening (3) by means of an actuator, said body being housed in the valve housing (1). According to the invention, pressure waves are avoided by at least one fluid drain channel (5) branching off the fluid passage (2) via at least one fluid drain opening (4) in the vicinity of the fluid outlet opening (3) and a device is provided in the valve housing for the alternate opening of the fluid drain opening (3) and the fluid outlet opening (4) such that fluid may continuously flow through the fluid passage (2).

The invention relates to a valve as well as a device and a method for generating a fluid pulse using the valve.

Conventional valves for the injection of combustible fuel in the combustion chamber of a combustion engine, so called combustible fuel injection valves, are usually constructed in such a manner that the combustible fuel fed to the combustible fuel injection valve is conducted to the combustion chamber exclusively through a combustible fuel injection opening provided on the combustible fuel injection valve. With some combustible fuel injection valves, in addition to the input line, a combustible fuel return line is also provided which permits the discharge of gas bubbles or works together with a pressure control unit.

Such a valve is known, for example, from DE 42 22 628 A1. In this connection, the valve which is designed as a combustible fuel injection valve is placed in a graduated receptacle hole. A combustible fuel input and a combustible fuel discharge channel are connected with an annular-space-like combustible fuel chamber which is formed between the combustible fuel injection valve and the graduated receptacle hole. From the combustible fuel chamber, the combustible fuel runs through filter bodies to the combustible fuel injection valve. The combustible fuel feedback channel is connected with a pressure regulator with which the pressure being created in the combustible fuel chamber is regulated in dependence on an air pressure in the combustion chamber.

DE 43 32 118 A1 describes a possibility of a mounting and an electrical contacting of the above described combustible fuel injection valve.

From U.S. Pat. No. 6,877,679 B2, an injection system is known with which a movable piston with a magnetic coil is provided in a combustible fuel injection valve. A fluid passageway is provided in the piston through which the fluid flows from a combustible fuel input opening to an injection opening. A combustible fuel return channel is connected to the combustible fuel input opening via a low pressure pump.

U.S. Pat. No. 6,412,704 B2 describes a combustible fuel injection valve with which the movement of a valve closing body is controlled with hydraulics activated with a piezo actuator.

Further combustible fuel injection valves are known from the U.S. Pat. Nos. 5,040,727 and 6,029,902. In this connection, a fuel dosing chamber which is connected to a combustible fuel input opening is located in the vicinity of an injection opening. Moreover, a degassing line is connected to the combustible fuel dosing chamber so that no undesired gas bubbles can collect in the combustible fuel dosing chamber.

DE 198 47 388 A1 discloses a fuel injection system with injection jets which can be cooled by fuel. In this connection, a return line that branches off in the vicinity of a jet opening is provided for cooling purposes. The return line is connected to a high pressure pump via a lockable shut-off valve. The shut-off valve is closed before the jet is opened. Due to this, the pressure created by the high pressure pump increases to the extent that a jet needle that closes the jet opening lifts. During this procedure, an opening of the return line provided in the vicinity of the jet opening always remains open. Due to this, the pressure created by the high pressure pump also acts upon the entire area of the return line. The return line or the return system has a certain elasticity. Due to this, the volume flow of the injected fuel cannot be precisely controlled. This can lead to relatively great inaccuracies particularly during multiple injections.

DE 196 39 149 C1 describes a similar injection jet. Also included is a bypass line connected via a flow-control valve with a high pressure line. The bypass line branches here, however, relatively far away from the jet opening. Also here, the bypass line remains open while the jet is being opened. To this extent, the same problems exist as with DE 198 47 388 A1.

During the opening and closing of a combustible fuel injection opening, waves of pressure occur throughout the entire line and pump system with conventional combustible fuel injection valves. In particular with short injection times and high injection frequencies, the pressure fluctuations caused by the pressure waves become so strong that the amount of combustible fuel injected during an injection procedure can no longer be precisely controlled.

With conventional combustible fuel injection valves, combustible fuel which is calm at first is accelerated during the injection procedure and expelled through the combustible fuel opening. The forces of inertia must be overcome for the acceleration of the combustible fuel. Due to this, a delay in time occurs until the maximum mass flow rate is conveyed through the combustible fuel opening. This time delay limits a further shortening of the opening times for combustible fuel injection valves. Such a shortening of the opening times would permit, in particular, multiple injections during one cycle of a combustion engine. Theoretical and experimental studies have shown that the combustion process can be further optimized with such multiple injections.

Object of the invention is to eliminate the disadvantages in accordance with the state of technology. In particular, a valve, a device and a method are to be specified for the generation of a fluid pulse with which a high mass flow rate of the conveyed fluid can be achieved immediately after a fluid output opening opens, even in case of extremely short fluid pulse times.

This object is solved by the features of claims 1, 8, 10 and 13. Useful embodiments of the invention result from the features of claims 2 to 7, 9, 11 and 12 as well as 14 to 18.

According to the provisions of the invention, it is provided for the valve that at least one fluid drain channel branches off from the fluid passageway via at least one fluid drain opening provided in the vicinity of the fluid output opening, and that a unit for the alternating opening of the fluid drain opening and the fluid output opening is provided in the valve housing so that fluid can flow interruptedly through the fluid passageway.

With the suggested valve, the fluid drain opening is alternately opened and the fluid output opening is closed or the fluid drain opening is closed and the fluid output opening is opened. The suggested valve works similarly to a double valve which comprises a main valve and a return valve which are alternately opened and closed. This ensures that the fluid flows uninterruptedly through the fluid passageway and at an essentially constant speed. The unit provided by the invention for the alternating opening of the fluid drain opening and the fluid output opening only causes a diversion of the fluid flowing out of the fluid passageway alternately through the fluid drain and the fluid output openings. Due to this, the fluid can no longer be accelerated when it passes through the fluid output opening. With this, the formation of pressure waves can be avoided. Significantly shortened opening times can be realized, wherein a high mass flow rate can be achieved immediately after the opening of the fluid output opening. The amount of fluid conveyed through the fluid output opening during a fluid pulse can be reproduced with great accuracy.

According to a particularly simple embodiment, it is provided that the valve closing body is accommodated in the fluid passageway.

A further advantageous embodiment of the invention is that the valve closing body and the fluid drain opening correspond to each other in such a manner that the valve closing body in the first position closes the fluid drain opening and releases it in the second position. This makes it possible to control the alternate opening of the fluid drain opening and the fluid output opening via a single control unit.

The control unit advantageously has a piezo actuator or a magnetic coil for movement the valve closing body. Several piezo actuators or also a combination of one piezo actuator and a hydraulic auxiliary unit can be provided as a control unit to move the valve closing body. Such control units enable short opening times as well as high opening frequencies.

A unit for cooling the fluid drain channel is usefully provided. In this connection, this can involve at least one or a plurality of cooling channels through which the fluid or a special cooling fluid flow to carry off heat. The fluid carrying off the heat or the cooling fluid can also be carried off via the fluid drain channel. A Peltier element can also be provided for cooling which is provided in the area of the fluid drain channel or is part of the fluid drain channel.

The valve provided by the invention can be a combustible fuel injection valve. In this case, the fluid is a combustible liquid fuel.

The valve provided by the invention can also be a pneumatic valve. In this case, the fluid is a gas, preferably air. The valve provided by the invention is particularly suitable as a pneumatic control valve for the generation of extremely short compressed air pulses.

According to further provisions of the invention, a device is provided for the generation of a fluid pulse with which the fluid inlet opening of the valve provided by the invention is connected to a source of pressure via a first line, and wherein the fluid drain channel is connected to a fluid supply via a second line provided down stream from the fluid drain opening.

A suitable drop in pressure is set between the source of pressure and the fluid supply so that an uninterrupted flow of the fluid is achieved through the fluid passageway at a specified flow speed. The setting of a suitable drop in pressure can be implemented with conventional shut-off valves or similar. If a shut-off valve is inserted in the second line, it is seen as advantageous that a similar drop in pressure is generated with this as with an opened fluid output opening. This ensures that, regardless of whether the fluid output opening or the fluid drain opening is open at the moment, approximately the same pressure is always present in the fluid passageway.

With the fluid supply, this can be a gas storage device, for example, a liquid gas container, or also the atmosphere. If the device is designed as a combustible fuel injection system, the fluid supply is, for example, a combustible fuel tank.

The suggested device is comparable to a conventional device for the generation of a fluid pulse with low pressure feedback.

According to further provisions of the invention, a device for the generation of a fluid pulse is provided with which the fluid inlet opening of the valve provided by the invention is connected to a source of pressure via a first line, and wherein the fluid drain opening is connected to the source of pressure via the second line.

With the source of pressure, this can be a high pressure pump or a pressure container. If the device is designed as a pneumatic device, the source of pressure can also be a compressor.

Also in this case, a drop in pressure is generated between the first and the second line which drop in pressure makes possible an uninterrupted flow through the fluid passageway. The drop in pressure can be generated, for example, by connecting the second line to a low pressure side of the source of pressure.

The suggested device is comparable to a conventional device for the generation of a fluid pulse which is designed based on the principle of high pressure feedback.

Advantageously, the control device comprises an electronic control unit for the movement of the valve closing body with which the opening time of the valve and the opening frequency can be controlled. The control can be performed based on measured or preset parameters. The electronic control unit can, in particular, be designed so that it can open and close the fluid output opening a plurality of times during one cycle of a combustion engine.

According to further provisions of the invention, a method for the generation of a fluid pulse is provided with the following steps:

Provision of a valve provided by the invention,

alternating opening of the fluid drain opening and the fluid output opening so that fluid is uninterruptedly flowing through the fluid passageway.

With the suggested method, the formation of pressure waves in a device for the generation of a fluid pulse can be avoided. Moreover, immediately after the valve closing body is opened, it can be used to convey a high, in particular, the maximum mass flow rate of fluid through the fluid output opening. This significantly reduces the opening times. This can be used, in particular, to implement multiple injections with the combustible fuel injection system and the combustion in a combustion engine can be further optimized.

According to an advantageous embodiment, the fluid flow is diverted alternately through the alternating opening of the fluid drain opening and the fluid output opening. Thus the fluid to be conveyed through the fluid output opening must not be separately accelerated during the generation of a fluid pulse. By diverting the fluid flow, the kinetic energy contained therein can be utilized immediately and the fluid pulse can be generated with this. The suggested diversion of the fluid flow is a simple way to avoid the generation of undesired pressure waves in the device for generation of fluid pulses.

According to a further embodiment of the method, the value closing body is used for the alternating opening of the fluid drain opening and the fluid output opening. In addition, the valve closing body can be moved back and forth between a first and a second position in the direction of the fluid output opening. The suggested steps of the method provide a particularly simple way to implement a suitable valve for the performance of the method or a device for the generation of a fluid pulse.

According to a further advantageous embodiment, a piezo actuator or a magnetic coil are used as the control unit for the movement of the valve closing body. Such control units make particularly short opening times possible.

Finally, as defined by a further feature of the method provided by the invention, the fluid drain channel is cooled.

The valve, the device and the method for the generation of a fluid pulse, each with a fluid output opening, a fluid drain channel and a fluid drain opening, have been described above. Naturally, it is possible that also a plurality of fluid output openings are provided for one valve. The fluid output opening can also be able to be locked with a valve plate or a cone-like embodied valve closing body. With respect to the at least one fluid output opening, embodiments are possible that are known for conventional valves, in particular, combustible fuel injection valves.

The valve and the device and the method for the generation of a fluid pulse, each with a fluid drain opening and a fluid drain channel, have been described above. Naturally, within the framework of this invention, it is also possible that a single fluid drain channel is designed as a branch and is connected to the fluid passageway via a plurality of fluid drain openings. The fluid drain opening can also be designed as a ring channel which is connected to at least one fluid drain channel. Naturally, it is also possible that a plurality of fluid drain channels with a plurality of fluid drain openings are connected to the fluid passageway. For example, two, three, four or five fluid drain openings can be provided. A minimum total cross section through which the fluid drains through the fluid drain channel is usefully greater than a maximum throughput cross section of the fluid output opening. This ensures that a sufficient flow speed of the fluid is always available. Altogether, throughout the entire device for the generation of a fluid pulse, the openings through which the fluid passes must be coordinated with each other in their through flow cross section in such a manner that a specific desired pressure is present in the fluid output opening.

The invention will now be described in more detail using examples based on the drawing.

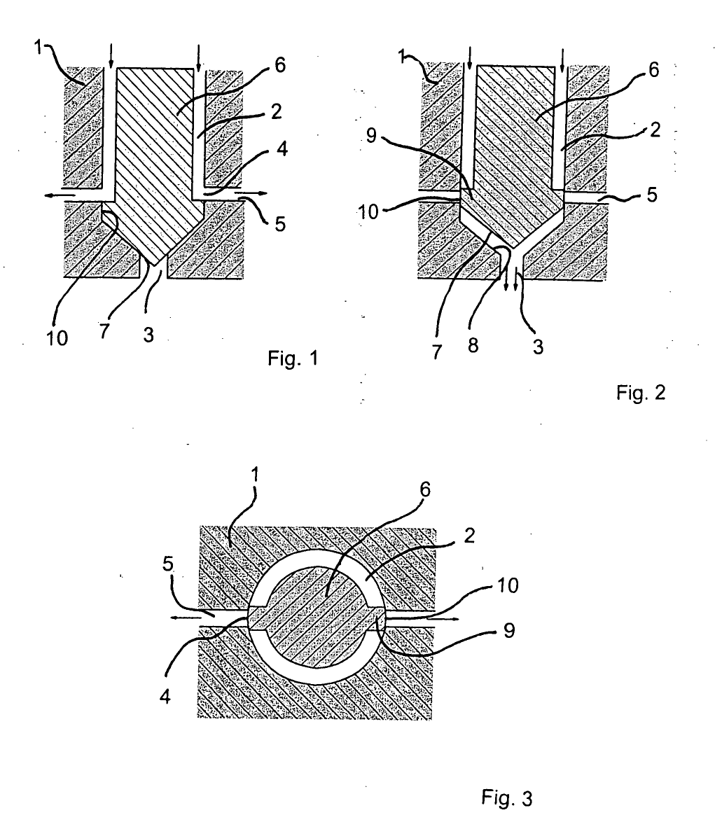

FIG. 1A valve with a valve closing body located in a first position,

FIG. 2 the valve as shown in FIG. 1, wherein the valve closing body is located in the second position,

FIG. 3 a top view as shown in FIG. 2,

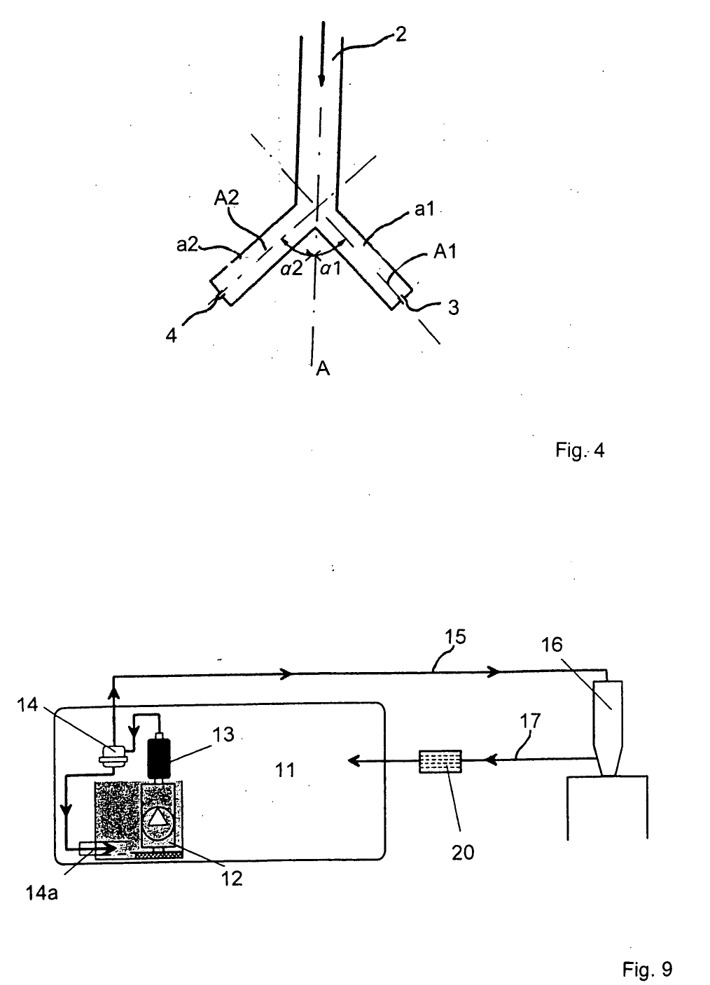

FIG. 4 a schematic view of a further valve,

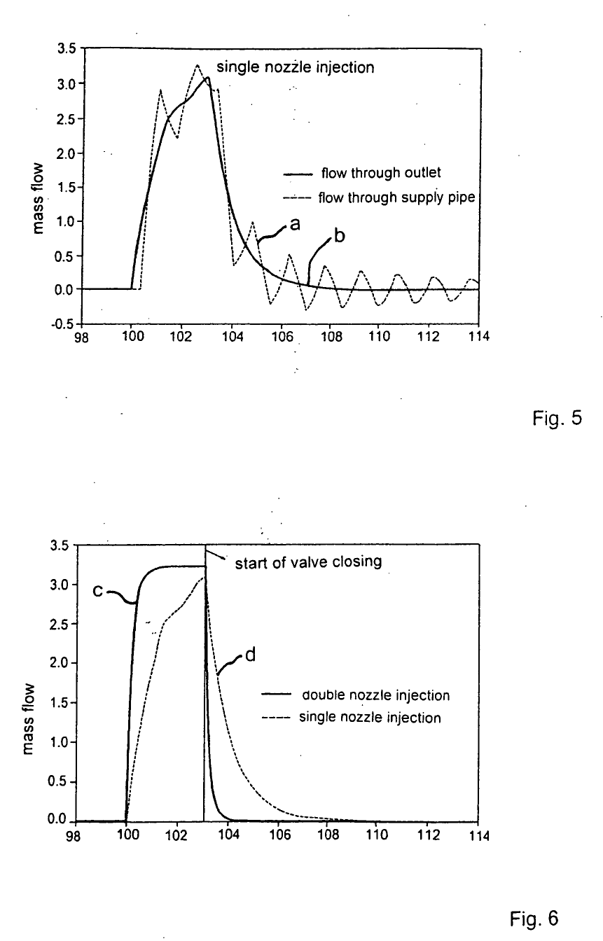

FIG. 5 the rate of the mass flow over the time for a valve in accordance with the state of technology,

FIG. 6 a comparison of the mass flow rate over the time for a valve in accordance with the state of technology to a valve provided by the invention,

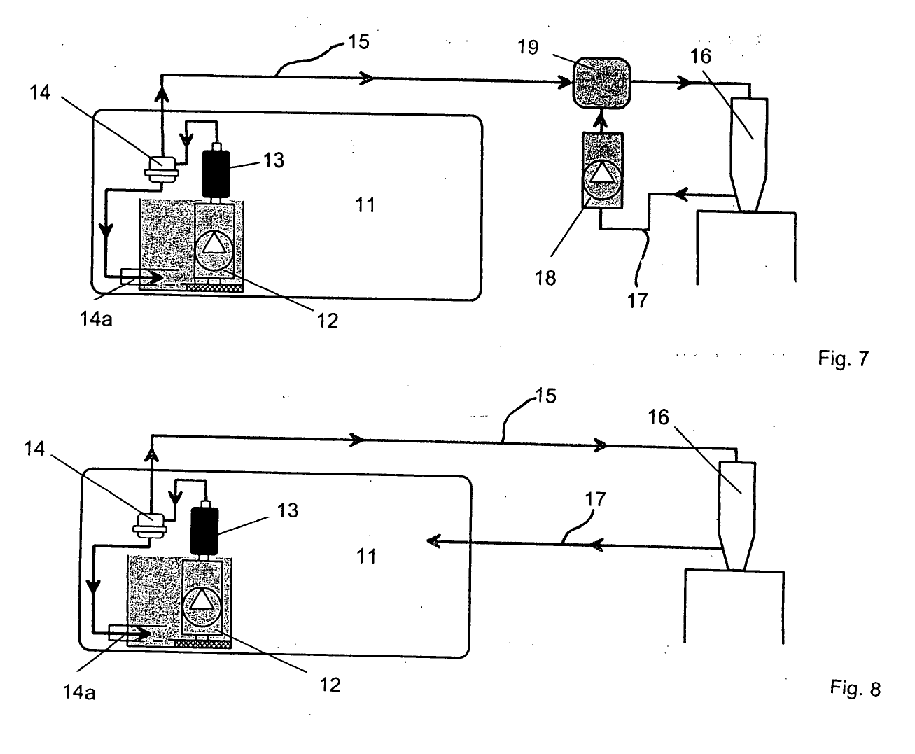

FIG. 7 a device for the generation of a fluid pulse with high pressure feedback,

FIG. 8 a device for the generation of a fluid pulse with low pressure feedback and

FIG. 9 a device as shown in FIG. 8 with cooling.

FIGS. 1 to 3 show a valve housing 1 provided with a fluid passageway 2 which has a fluid output opening 3. In the vicinity of fluid output opening 3, two fluid drain channels 5 connected to the fluid passageway 2 branch off via fluid drain openings 4.

A valve closing body 6 is provided in the fluid passageway 2 which can be moved back and forth with a (not shown here) control unit in the axial direction. The valve closing body 6 has on its free end, here, cone-shaped, first closing surfaces 7 which correspond in such a way with the second closing surfaces 8 on the valve housing 1 that the fluid drain opening 3 can be closed in a first position of the valve closing body 6—as is shown in FIG. 1.

Moreover, the valve closing body 6 has radially extending protrusions 9 with third closing surfaces 10 provided on them. The third closing surfaces 10 adjoin the first closing surfaces 7 or are arranged close to the first closing surfaces 7. The protrusions 9 or the third closing surfaces 10 provided thereon only extend in axial direction over a lower section of the valve closing body 6.

FIG. 1 shows the valve closing body 6 in the first position in which the fluid output opening 3 is closed and the fluid drain openings 4 are open at the same time. In the first position, the fluid drain openings 4 are open and the fluid flows through the fluid passageway 2 into the fluid drain channels 5.

FIG. 2 shows the valve closing body 6 in a second position for which the first 7 and the second closing surfaces 8 are distanced from each other. In the second position, the third closing surfaces 10 close the fluid drain openings 4. In this case, the fluid 2 flows through the fluid passageway 2 and through the fluid output opening 3.

FIG. 3 shows a top view as per FIG. 2. From this it can be seen that the fluid passageway 2 is designed at least in the area of the valve closing body 6 at least section wise in an annular-space-like manner.

Although not shown in FIGS. 1 to 3, it goes without saying that a fluid inlet opening for the input of fluid is provided in the valve housing 1 up stream from the fluid passageway 2.

FIG. 4 shows a schematic view of a further valve. In this connection, the fluid passageway 2 branches in a first branch a1, at whose end the fluid output opening is provided. A second branch a2 is arranged symmetrically to the first branch a1 in relation to an axis A of the fluid passageway 2. In other words, a first angle α1 between a first axis A1 of the first branch a1 and the axis A is just as large as a second angle α2 between the axis A and a second axis A2 of the second branch a2. The fluid drain opening 4 is arranged down stream from a fluid drain channel not shown separately here. The fluid output opening 3 and the fluid drain opening 4 are each provided with a (not shown here) valve with which the fluid output opening and the fluid drain opening can be alternately opened or closed. The suggested further valve has the advantage that; due to the symmetrical arrangement of the branches a1, a2 in relation to the fluid passageway 2, the flow resistance down steam from the fluid passageway can be easily kept constant to a large extent, regardless of whether the fluid output or the fluid drain opening is open at the moment. With this, any generation whatsoever of pressure waves can be avoided in a particularly simple way.

FIG. 5 shows a numeric simulation of the mass flow rate over the time for a valve in accordance with the state of technology. The curve lit: a gives the mass flow rate over the time in a first line which is connected to a fluid inlet opening for the input of fluid. The curve lit. b gives the progression of the mass flow rate over the time in a section of the fluid passageway 2 which is located immediately in front of fluid output opening 3. As is particularly clear from the curve lit. a, pressure waves occur in the first line with conventional valves. As is clear in curve lit. b, the mass flow rate increases continuously after the opening of the fluid output opening up to a maximum value. In other words, the maximum mass flow rate is not reached immediately after the opening of the fluid output opening. This effect is explained in accordance with current knowledge in that immediately before the opening of the fluid output opening, the fluid is calm and must first be accelerated. The acceleration causes a finite change in speed of the fluid conveyed through the fluid output opening. When the fluid output opening is opened, a negative pressure wave occurs which counteracts the actual acceleration of the fluid.

FIG. 6 shows a comparison of the mass flow rate over the time for a conventional valve with a valve provided by the invention. The curve lit. c gives the progression of the mass flow rate over the time for a conventional valve and the curve lit. d gives the progression of the mass flow rate for a valve provided by the invention. FIG. 6 shows clearly that the mass flow rate for the valve provided by the invention is much greater immediately after the opening of the fluid output opening than with the valve in accordance with the state of technology. With the valve provided by the invention, a maximum value of the mass flow rate is already achieved one millisecond after the opening of the fluid output opening. With this, a particularly high mass flow rate can be implemented reproducibly with significantly shortened opening times. The opening times can thus be significantly shortened. Regardless of this, it is possible to achieve the maximum mass flow rate practically immediately after the fluid output opening opens. The advantageous effects of the valve provided by the invention can be traced, in particular, to the fact that the fluid no longer has to be accelerated before the opening of the fluid output opening. A particularly existing fluid flow through the fluid passageway 2 is only diverted by the movement of the valve closing body 6.

FIGS. 7 and 8 show devices for the generation of a fluid pulse based on the example of a combustible fuel injection system for combustible liquid fuel. The device shown in FIG. 7 is a combustible fuel injection system with high pressure feedback. A fuel pump 12 is provided in a fuel tank 11. Under intermediate connection of a fuel filter 13 and a pressure regulator 14, the fuel pump is connected via a first line 15 to the fluid inlet opening of the combustible fuel injection valve generally designated with the reference designation 16. Moreover, the pressure regulator 14 is connected to the fuel pump 12 under intermediate connection of a ram jet pump 14a. A second line 7 is connected to the fluid drain opening/openings via the fluid drain channel/channels. The second line 17 is connected to a high pressure pump 18 up stream which in turn is connected to a high pressure container 19 connected in the first line 15.

FIG. 8 shows a combustible fuel injection system with low pressure feedback. In this connection, the second line 17 is immediately connected to the fuel tank 11. No high pressure container is connected in the first line 15.

With both versions of the combustible fuel injection systems shown, fluid is uninterruptedly conveyed through the valve 16. In this connection, the fluid is continuously under the required injection pressure or pressure for the generation of a fluid pulse.

The suggested device for the generation of a fluid pulse can be used as a combustible fuel injection system for the injection of combustible liquid fuel with combustion engines, in particular, gasoline or diesel engines. But the suggested valve provided by the invention or the device for the generation of a fluid pulse can also be used for pneumatic units. In this case, a gas, for example, compressed air, is used as the fluid. The suggested valve enables the generation of extremely short opening times and thus extremely short valve pulses which enable particularly fast and precise control of pneumatic devices.

FIG. 9 shows a version of the combustible fuel injection system as shown in FIG. 8. In this connection, a cooling unit 20 is provided in the second line 17. The cooling unit 20 cools the fluid which is returned to the fuel tank 11, in particular, combustible liquid fuel. With this, the undesired heating up of the fluid in the fuel tank is prevented.

The cooling unit 20 can be a conventional cooling unit, for example, a heat exchanger or similar.

### REFERENCE DESIGNATION LIST

1 Valve housing
2 Fluid passageway
3 Fluid output opening
4 Fluid drain opening
5 Fluid drain channel
6 Valve closing body
7 First closing surfaces
8 Second closing surfaces
9 Protrusion
10 Third closing surfaces
11 Fuel tank
12 Fuel pump
13 Fuel filter
14 Pressure regulator
14a Ram jet pump
15 First line
16 Valve
17 Second line
18 High pressure pump
19 High pressure container
20 Cooling unit
α1, α2 First, second angle
A Axis
A1 First axis
A2 Second axis
a1 First branch
a2 Second branch

1-18. (canceled)

19. Valve, having a valve housing (1) in which a fluid inlet opening is provided which is connected via a fluid passageway (2) to at least one fluid output opening provided down stream from the fluid inlet opening, and wherein a valve closing body (6) is accommodated in the valve housing (1) which valve closing body (6) can be moved via a control unit having a piezo actuator or a magnetic coil from a first position releasing a fluid output opening (3) to a second position closing the fluid output opening (3), wherein at least one fluid drain channel (5) branches off from the fluid passageway (2) via at least one fluid drain opening (4) provided in the vicinity of the fluid output opening (3), wherein the valve closing body (6) and the fluid drain opening (4) correspond to each other in such a manner that the valve closing body (6) closes the fluid drain opening (4) in the first position and releases it in the second position so that fluid flows uninterruptedly and at an essentially constant flow speed through the fluid passageway (2).

20. Valve as defined in claim 19, wherein the valve closing body (6) is accommodated in the fluid passageway (2).

21. Valve as defined in claim 19, wherein a unit for cooling the fluid drain channel (5) is provided.

22. Valve as defined in claim 19, wherein the valve (16) is a combustible fuel injection valve and the fluid is a combustible liquid fuel.

23. Valve as defined in claim 19, wherein the valve (16) is a pneumatic valve and the fluid is a gas.

24. Device for the generation of a fluid pulse for which the fluid inlet opening of the valve (16) as defined in claim 19 is connected to a source of pressure via a first line (15), and wherein the fluid drain channel (5) is connected to a fluid supply via a second line (17) provided down stream from the fluid drain opening (4).

25. Device as defined in claim 24, wherein the fluid supply is a gas storage device or a combustible fuel tank (11).

26. Device for the generation of a fluid pulse for which the fluid inlet opening of the valve (16) as defined in claim 19 is connected to a high pressure side of a source of pressure via a first line (15) and wherein the fluid drain opening (3) is connected to a low pressure side of the source of pressure via a second line (17).

27. Device as defined in claim 26, wherein the source of pressure is a high pressure pump (18) or a pressure container (19).

28. Device as defined in claim 26, wherein the source of pressure is a compressor.

29. Method for the generation of a fluid pulse with the following steps:
Provision of a valve (16) as defined in claim 19,
alternating opening of the fluid drain opening (4) and the fluid output opening (3) so that fluid is uninterruptedly flowing through the fluid passageway (2) at an essentially constant speed of flow.

30. Method as defined in claim 29, wherein the fluid flow is alternately diverted by the alternating opening of the fluid drain opening (4) and the fluid output opening (3).

31. Method as defined in one of the claim 29, wherein the fluid drain channel (5) is cooled.

32. Method as defined in one of the claim 29, wherein the fluid inlet opening of the valve (16) is connected to a source of pressure via a first line (15), and wherein the fluid drain channel (5) is connected to a fluid supply via a second line (17) provided down stream from the fluid drain opening (4).

33. Method as defined in claim 32, wherein a shut-off valve is connected in the second line (17) to control an essentially constant speed of flow, wherein the shut-off valve is designed in such a manner that a similar drop in pressure is generated as when the fluid output opening (3) is open.
